(19) United States
(12) Patent Application Publication
(10) Pub. No.: US 2010/0290097 A1
(43) Pub. Date: Nov. 18, 2010

(54) Image Data Checking System

(76) Inventors: Kashiko Kodate, Tokyo (JP); Eriko Watanabe, Tokyo (JP)

Correspondence Address: EDELL, SHAPIRO & FINNAN, LLC, 1901 RESEARCH BLVD., SUITE 400, ROCKVILLE, MD, 20850-3164, US

(21) Appl. No.: 12/599,943

(22) PCT Filed: May 14, 2008
(86) PCT No.: PCT/JP2008/058859

§ 371 Date: Aug. 4, 2010

(30) Foreign Application Priority Data
May 14, 2007 (JP) 2007-153340

(51) Int. Cl. G03H 1/22

(52) U.S. Cl. 359/2

(57) ABSTRACT

A checking system is provided for making it possible to carry out an effective censor for browsing image data that can be in a browsing state at a site on a network An image data checking system is provided with an image database (2) in which a plurality of registering image data are registered; a retrieving light generating means (3) for generating retrieving light in accordance with browsing image data; a checking means (4) for checking the browsing image data and the registering image data, wherein the image database has a holographic recording medium (20) provided with a hologram recording layer (21) on which image data are recorded by an interference fringe (24) resulting from information light (32) generated in accordance with the registering image data and reference mark light (33) generated in accordance with a reference mark, and the checking means irradiates the retrieving light (36) generated by the retrieving light generating means to the hologram recording layer, detects a reference mark light (37) to be reproduced, and checks the browsing image data with the registering image data.

### TECHNICAL FIELD

The present invention relates to a checking system for checking browsing image data that can be in a browsing state on a site on a network.

### BACKGROUND ART

In recent years, copyright infringement on the Internet has been acknowledged as a problem, along with the digitalization of information such as novels, music, films and pictures, and the popularization of the Internet. This is due to the fact that the digitalization of information allows the information to be copied without degrading the quality, also to the ease of secondary use or tertiary use of information such as editing or adaptation of information, and further to the environment in which other people's copyrighted works can be easily exploited because of the capability of public transmission via the Internet. In particular, not only groups such as companies but also respective individuals are placed under these environments, thereby making prevention and management of copyright infringement more difficult.

Recently, while video sharing service for sharing moving images on the Internet has been provided, copyright infringement has becomes a big problem in this video sharing service. The video sharing service refers to a service in which sharing of moving image data uploaded by a user allows other users to download the moving image data, thereby allowing the moving images to be made public and browsed. Tens of thousands of pieces of moving image data are posted per day on this video sharing service, and those pieces of moving image data actually include a number of illegal pieces of data which infringe copyrights. For example, films, TV programs, live images, promotion videos, etc, are uploaded without the permission from the owners of the copyrights.

Conventionally, the management of copyrights in the video sharing service only states in terms of service or the like that it is forbidden to post moving image data which infringes a copyright, and is left to each user's moral without providing any special censorship system. Even if illegal moving image data is uploaded, data pointed out by a third party as illegal moving image data is only deleted. While owners of copyrights and the like reproduce and view moving image data to retrieve illegal moving image data, and then report the infringement, it is not realistic to check every piece of moving image data increasing by tens of thousands of pieces from day to day. Furthermore, even if illegal moving image data is reported and deleted, the user often posts the illegal moving image data again, and therefore, the conventional countermeasure is not effective.

Meanwhile, conventional image retrieval techniques utilizing optical correlation include a technique using, for retrieving images input from a great deal of recorded image data, optical correlation with a thin-screen liquid crystal element, a thin hologram, or the like as a display element. However, the liquid crystal element carries out optical correlation processing while switching the great deal of recorded image data, and thus requires electrical control for switching images, and the time for each correlation is limited. Furthermore, since images accumulated from a recording medium are transferred to the liquid crystal display element before carrying out optical correlation processing, the speed of the optical correlation processing is limited also by the transfer rate. Moreover, in the case of the thin hologram, it is difficult to increase the storage capacity or the recording density.

On the other hand, holographic memories on which two-dimensional image data can be recorded have been developed as one of next-generation memories, and above all, random-accessible collinear-type holographic memories allow reference light to coaxially interfere with information light, thereby allowing large volumes of data to be recorded and reproduced (Patent Document 1). Thus, as an image retrieval technique, the technique has been proposed in which optical correlation calculation is carried out by using a volume-type (thick) hologram that is a collinear type holographic memory (Non-Patent Document 1).

[Patent Document 1] Japanese Patent No. 3403068

[Non-Patent Document 1] Eriko Watanabe, et al., “Image Search Engine with All-Optical Ultrahigh-Speed Optical Correlation”, Extended Abstracts of Optics Japan 2005, pp. 260-261, 2005

### DISCLOSURE OF THE INVENTION

In view of the background art described above, an object of the present invention is to provide a checking system which makes it possible to carry out effective censorship with respect to browsing image data that can be in a browsing state on a site on a network. Furthermore, another object of the present invention is to provide management of copyrights and a new business model with the use of the aforementioned checking system.

A checking system according to the present invention consists in a checking system for checking browsing image data that can be in a browsing state on a site on a network, characterized in that it comprises: an image database in which multiple pieces of registration image data are registered; a retrieving light generating means for generating retrieving light on the basis of the browsing image data; and a checking means for checking the browsing image data against the registration image data registered in the image database, the image database includes a holographic recording medium comprising a hologram recording layer on which image data is recorded by an interference fringe resulting from information light generated on the basis of registration image data and reference mark light generated on the basis of a reference mark, and the checking means irradiates the hologram recording layer of the holographic recording medium with retrieving light generated by the retrieving light generating means, and detect reproduced reference mark light to check the browsing image data against the registration image data.

Further, in the checking system, it is preferable to add identification data to the browsing image data when the browsing image data is registered in the image database, and it is further preferable to change a condition for browsing the browsing image data on the basis of the identification data.

Further, in the checking system, it is preferable to provide the holographic recording medium with an address layer for specifying a location, and when reference mark light is reproduced by the retrieving light, to specify the location of a reference fringe reproducing the reference mark light by using the address layer and to specify the browsing image data from the location of the interference fringe.

Further, in the checking system, when the browsing image data is registered in the image database, information regarding the image data may be provided to a registrant who registers the image data in the image database.

Further, in the checking system, it is preferable to carry out irradiation with the retrieving light while rotating the holographic recording medium which has the shape of a disc.

Further, in the checking system, it is preferable that the information light be spatially modulated by an image for registration generated from an reproduced image of the registration image data displayed on a partial region of a spatial light modulator, and that the reference mark light be modulated by the reference mark displayed on another partial region of the spatial light modulator.

Further, in the checking system, it is preferable that a partial region of the spatial light modulator be divided into a plurality of spaced-apart regions, that the registration image data be divided and displayed on the plurality of spaced-apart regions, and that at least a portion of the reference mark be displayed between the plurality of spaced-apart regions.

Further, in the checking system, it is preferable that the retrieving light be spatially modulated by an image for retrieval generated from a reproduced image of the browsing image data, and that the image for retrieval be displayed on a partial region of the spatial light modulator on which the image for registration is displayed.

Further, in the checking system, it is preferable to provide the registration image data with at least one keyword, to add at least one keyword data to the browsing image data, and for the checking means to first irradiate, with retrieving light, the holographic recording medium on which the registration image data provided with the keyword acquired from the keyword data is recorded, when the checking means checks the browsing image data.

Further, in the checking system, it is preferable that at least moving image data be contained in the registration image data, that the information light be generated on the basis of a still image of frame of moving image data extracted from reproduced moving images obtained by reproducing the moving image data, and that the number of frames per unit time extracted from the reproduced moving images be variable.

The use of the checking system according to the present invention allows browsing image data that can be in a browsing state on a site on a network to be checked against registration image data registered in an image database. Therefore, the management of the registration image data and the protection or licensing of copyrights can be collectively put into execution. Furthermore, the browsing image data can be censored within the range of registration in the image database, and infringement due to illegal image data uploaded and further, exercise of right by the registrant can be avoided. Other advantageous effects will be described in the following embodiments.

### BRIEF DESCRIPTION OF THE DRAWINGS

FIG. 1 a schematic configuration diagram illustrating a checking system according to the present invention.

FIG. 2 a block diagram schematically illustrating data flow.

FIG. 3 a configuration diagram of a checking server.

FIG. 4 a flowchart of image processing in an information processing device.

FIG. 5(A) a schematic diagram illustrating a display surface in a spatial light modulator for recording, and (B) a schematic diagram illustrating the operation of recording an interference fringe resulting from information light and reference mark light.

FIG. 6 a schematic diagram illustrating a display surface in a spatial light modulator when recording is to be carried out in another display mode.

FIG. 7 a diagram expressing the relationship between the location of a reference mark and an interference fringe written in the hologram.

FIG. 8(A) a schematic diagram illustrating a display surface in a spatial light modulator for recording in yet another display mode, (B) an example of an image for registration, and (C) a diagram illustrating the state of a divided image for registration being displayed.

FIG. 9(A) to (C) diagrams showing error rates in databases.

FIGS. 10(A) and (B) diagrams showing error rates in databases.

FIG. 11(A) to (C) diagrams showing error rates in databases.

FIG. 12 a flowchart of processing for checking in a checking server.

FIG. 13(A) a schematic diagram illustrating a display surface in a spatial light modulator for checking, and (B) a schematic diagram illustrating the operation of checking with retrieving light.

FIG. 14(A) a schematic diagram illustrating a display surface in a spatial light modulator for checking in another display mode, (B) a schematic diagram illustrating the operation of checking with retrieving light, and (C) a modification example of (C).

FIG. 15 a diagram illustrating a login screen of a checking server 1.

FIG. 16 a diagram illustrating a registration screen for registration image data.

FIG. 17 a diagram illustrating a screen for results of checking registration image data.

### BEST MODE FOR CARRYING OUT THE INVENTION

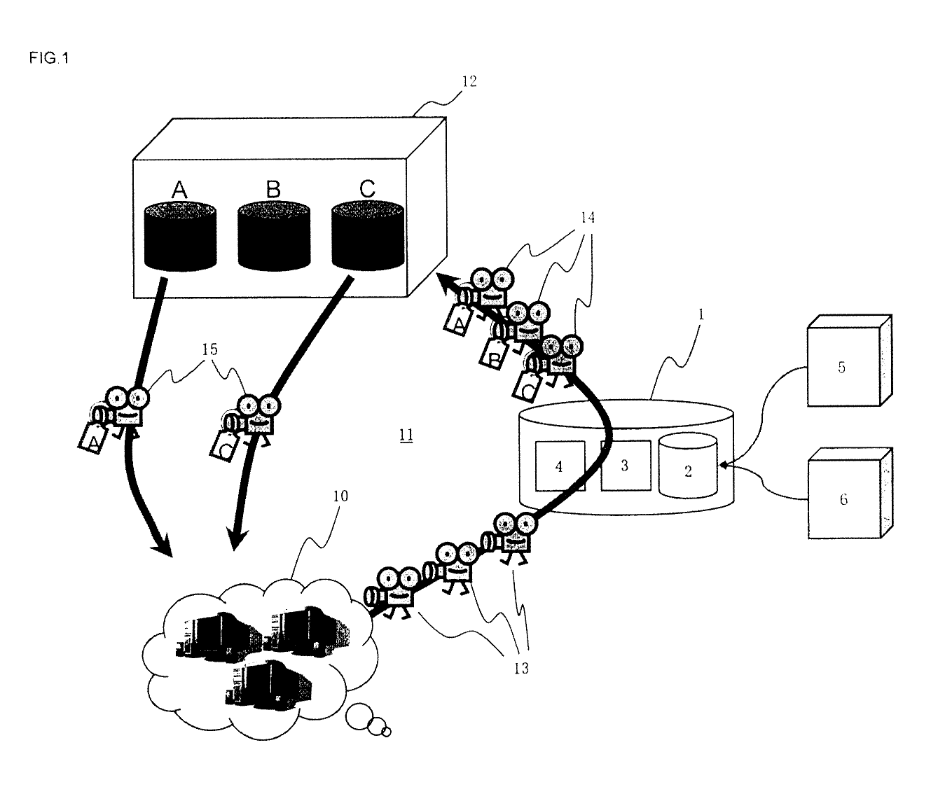

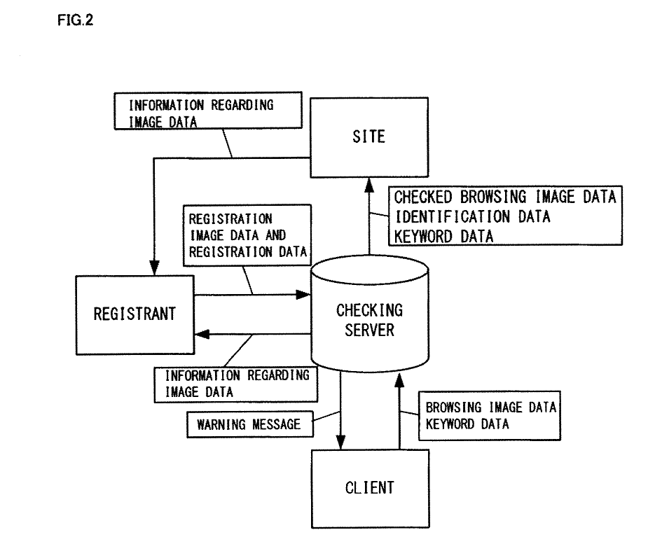

While embodiments of the present invention will be described below with reference to the drawings, the present invention is not to be considered limited to the following examples. FIG. 1 is a schematic configuration diagram illustrating a checking system according to the present invention, and FIG. 2 is a block diagram schematically illustrating a data flow. In FIG. 1, a network 11 is formed to which a group of clients 10 is connected, and on the network 11, a site 12 is started which provides image data that can be in a browsing state to the group of clients 10, and a checking server 1 is provided which checks browsing image data 13 that can be in a browsing state on the site 12. First of all, the entire checking system and a business model thereof will be schematically described, and a specific configuration of the checking system will be then described in detail.

The checking sever 1 is provided with an image database 2 in which multiple pieces of registration image data are registered, a retrieving light generating means 3 for generating retrieving light on the basis of the browsing image data 13, and a checking means 4 for checking the browsing image data against the registration image data registered in the image database 2. The registration image data is provided by registrants 5, 6, and registered in the image database 2. It is to be noted that image data includes moving image data and still image data, and it is preferable that at least moving image data (registration moving image data) be contained as the registration image data, because of currently increased requests of checking systems for moving image data.

The registrants 5, 6 refer to, for example, the operator of the site 12, or the owner of copyright or producer for the registration image data. As shown in FIG. 2, registration data such as the title, browsing condition, and keyword for the registration image data can be also registered at the same time here.

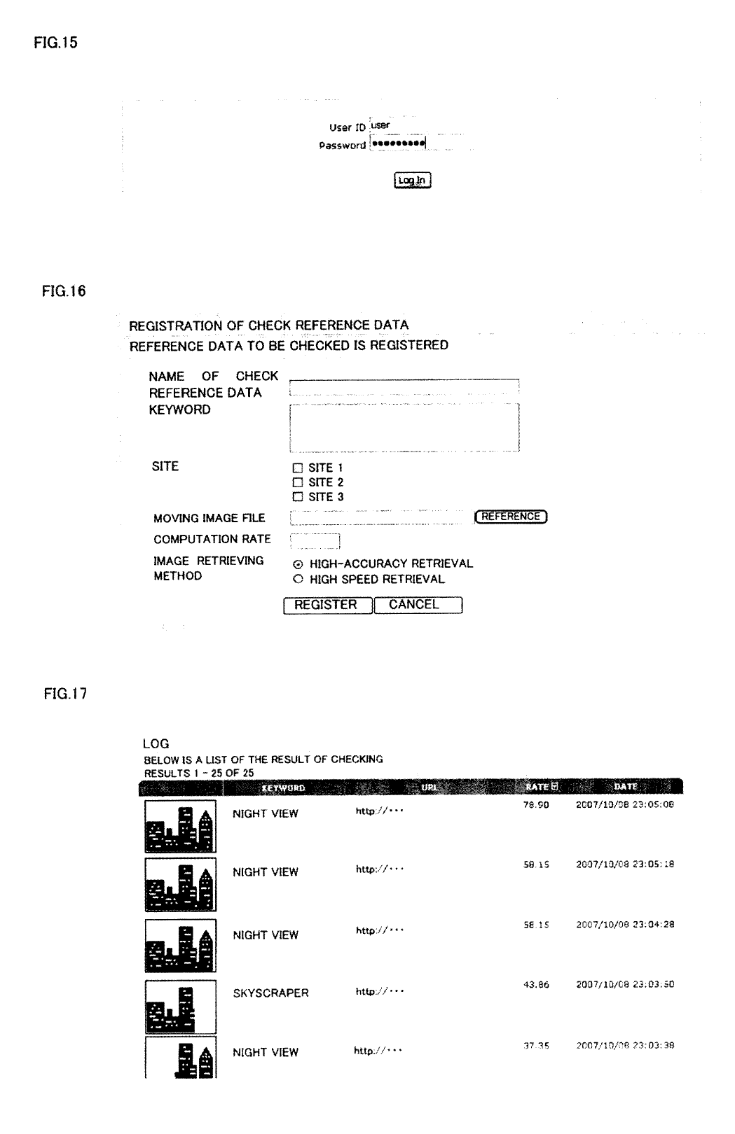

FIGS. 15 and 16 show a specific embodiment for the registrants 5, 6 to provide the registration image data to the checking server 1. FIG. 15 shows a login screen of the checking server 1, which is displayed when the registrants 5, 6 access the checking server 1. The login screen is provided with a box into which the name of the registrant and a password set in advance for each registrant can be entered. Entering the name of the registrant and the password allows the registrant to log into the checking server 1. It is to be noted that the name of the registrant and the password are separately registered in the checking server 1.

FIG. 16 shows a registration screen for the registration image data, which is displayed when the registrants 5, 6 register the registration image data in the checking server 1. The registration screen is provided with, for example, boxes into which the name of data, a keyword, and the computation rate are to be entered, check boxes for specifying a site to be retrieved, a box in which image data is to be registered (uploaded), and a check box for specifying a method for retrieving moving images. The name of the registration image data is entered in the box for the name of data, and an arbitrary keyword is entered in the keyword box. It is to be noted that the keyword box may be configured in such a way that a keyword is selected from multiple keywords set in advance. The computation for system operation can be entered in the box for the computation rate, and the box is configured in such a way that the computation for system operation can be set at a rate of 1 to 100%. The computation can be set on the basis of the compression ratio, resolution, etc. of the registration image data, and for example, when the computation is 100%, the registration image data is used directly without being compressed, and the computation can be reduced depending on the compression ratio. When the computation is increased, the accuracy is increased while the processing time is increased. Since there is a trade-off relationship between the accuracy and the processing time, the optimum computation is calculated depending on the condition for using the system. It is to be noted that the service use charge may be changed depending on the computation; the system may be created so that a numerical value entered as the computation can be recognized to change the service use charge automatically.

In FIG. 16, the site to be retrieved can be specified, which means that the site which needs to be retrieved can be selected. However, if all of the sites are to be retrieved in principle, the check boxes are not necessary. It is to be noted that the service use charge may be changed depending on the number or types of sites to be specified, or the system may be created so that whether or not to be checked can be recognized to change the service use charge automatically. Furthermore, in FIG. 16, the method for retrieving moving images is configured in such a way that high-accuracy retrieval or standard retrieval can be selected. For example, a higher threshold value is set to check only sites highly coincident with the registration image data in the case of the high-accuracy retrieval, while a lower threshold value is set to allow sites even similar to the registration image data to be retrieved in the case of the standard retrieval.

The group of clients 10 is composed of multiple clients using the site 12 and connected to the network 11, and can request the server for the site 12 to allow image data to be browsed. For example, as the group of clients 10, users of an image sharing site and members of paid content can be cited, and as a specific terminal device, personal computers, personal digital assistants, cellular phones, etc. can be cited.

The network 11 refers to a telecommunication network connecting between the terminal devices of the clients, and the Internet, a WAN (Wide Area Network), a LAN (Local Area Network), etc. can be sited as the network 11.

The site 12 has content prepared for providing browsing image data to the group of clients 10, and in FIG. 1, has types A, B, and C of content prepared, which differ from each other in browsing condition. As the types A, B, and C of content, for example, completely free content, content only partially allowed to be viewed, paid content, etc. can be cited. The site 12 can also require a keyword to be set on posting for browsing image data to be posted.

The browsing image data 13 is checked by the checking server 1, and can be then in a browsing state on the site 12. In FIG. 1, the browsing image data 13 is uploaded from the group of clients 10 via the network 11 to the server for the site 12. It is to be noted that the uploaded browsing image data 15 is, in response to a request for browsing from the other client, downloaded via the network 11 to the terminal device owned by the client. The browsing image data 13 may be brought into a browsing state by someone other than the clients, or may be transmitted to the site 12 by a means other than the network Further, while only a link is put to the site 12, the browsing image data 13 itself may be stored in the terminal device owned by the provider of the image data. When a request for browsing is made from the other client via the link put to the site 12, the browsing image data is directly downloaded from the terminal device owned by the provider to the terminal device owned by the other client.

Furthermore, it is preferable to add, to the browsing image data 13, at least one piece of keyword data for making the checking and the retrieval easier (see FIG. 2). The keyword data may be optionally selected by the person who posts the browsing image data 13, or a keyword may be set in advance, which specifies the field of the image data. Alternatively, a configuration may be employed in which posting on the site 12 is not allowed unless a keyword is entered. This keyword data may be used when the client retrieves an image on the site 12, or may be used for making the checking easier in the image database 2 of the checking server 1. For example, when image data is to be registered in the image database 2, a keyword may be recorded as registration data to carry out checking from image data corresponding to the keyword data, or image data may be registered as the image database 2 for each field or keyword to carry out checking from a region corresponding to the keyword data.

It is preferable to add identification data to the checked browsing image data 14 which has been checked by the checking server 1. The identification data can be the data that is history of checking finished in the checking server 1 or the data that identifies whether or not the browsing image data 13 is registered in the image database 2, and the data that may further contain a portion of the browsing condition or registration data when the browsing image data 13 is registered in the image database 2.

For example, when the browsing image data 14 to which identification data of checking finished has been added in the checking server 1 is downloaded to the other client and posted again from the other client, the checking server 1 can recognize the identification data of checking finished to determine whether or not checking is necessary for the browsing image data 14 to which the identification data has been added. Furthermore, if information on whether or not registered in the image database 2 is contained as identification data, it is possible to change the browsing condition depending on whether or not to be registered, or to manage image data on the network. Moreover, if information such as a title for an image and a browsing condition is also contained in the identification data, setting or management of more detailed browsing condition is made possible.

As the browsing condition, for example, deleting image data without allowing the image data to be browsed, treating image data as charged content, charging for image data depending on the number of browsing records, bringing only a portion of image data into content allowed to be viewed, bringing image data into invalid content, etc. can be cited.

In FIG. 1, the browsing image data 13 is checked against the image database 2 of the checking server 1, to which identification data A to C is added depending on the checking result, and uploaded onto each content of A, B, or C prepared on the site 12, on the basis of the identification data A to C.

It is to be noted that a configuration may be employed in which the identification data is added only to data registered in the image database 2, of the browsing image data. Alternatively, when processing of the browsing image data is carried out depending on the checking result in the checking server 1, the identification data may or may not be added to the browsing image data. For example, if image data registered in the image database 2 is not allowed to be browsed or uploaded at all, the browsing image data may be deleted in the checking server 1, and any identification data may or may not be added to the browsing image data to be uploaded onto the site 12. In addition, only if the aim is to merely survey data or manage how many times image data is posted, the information may be provided to the registrant in the checking server 1, and identification data may or may not be added to the browsing image data 13.

Furthermore, when the browsing image data is registered in the image database 2, the checking server 1 or the site 12 may provide information regarding the image data to the registrant who has registered the image data in the image database 2 (see FIG. 2). The information regarding the image data includes, for example, the number of posting records for the registered image data, the number of browsing (download) records, information on the client who posts the image data, etc.

Furthermore, the checking server 1 transmits, to the client who has posted the image data registered in the image database 2, a warning message which warns that posting the image data infringes the copyright (see FIG. 2). The awareness of the group of clients 10 to copyright can be enhanced by transmitting such a warning message.

The use of the checking system described above allows each of the registrants 5, 6 to collectively put the management of the registration image data and the protection or licensing of copyrights into execution on the network 11 by registering image data desired to be managed, as the registration image data, in the image database 2. Furthermore, the site 12 can censor the browsing image data within the range of registration in the image database 2, and can avoid infringement due to illegal image data uploaded, and further avoid exercise of right by the registrant.

More specifically, the checking server 1 can provide, to the registrants 5, 6, service of registering in the image database 2 image data desired to be managed, and also provide service of acting for a part of management of the registration image data. Furthermore, the checking server 1 can provide, to the site 12, service of censoring the browsing image data within the range of registration in the image database 2, and also provide service of acting for a part of management of the browsing image data. It is to be noted that the registrants 5, 6 or the site 12 itself can also provide the checking server 1.

FIG. 17 shows a screen for results of checking the browsing image data of each site against the registration image data by the checking server 1. Thumbnail images for the browsing image data are displayed on the left column of the result screen in FIG. 17, whereas keywords set for the browsing image data, information for specifying locations on the network, such as URL (Uniform Resource Locator) of the browsing image data, “Rate” as the coincidence rate against the registration image data, and the time for checking are displayed to the right side of the thumbnail images.

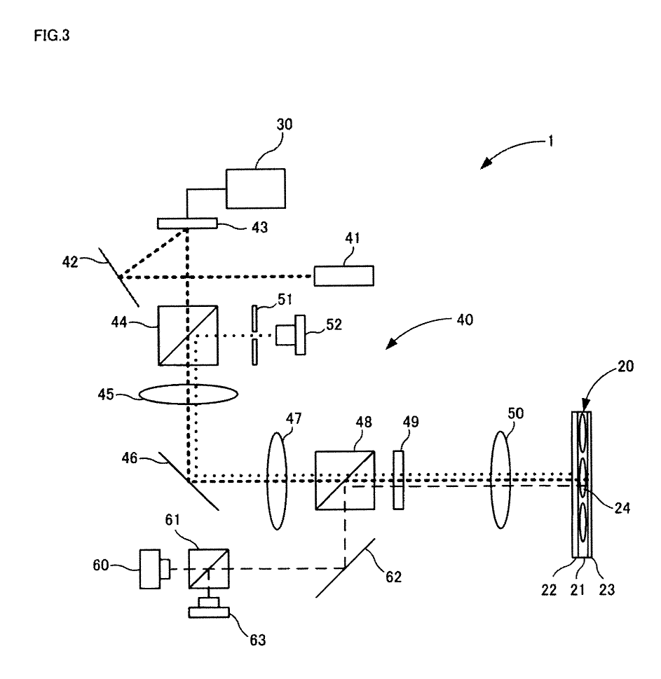

Now, specific configuration and operation in the checking server 1 will be described with reference to FIGS. 3 to 9. FIG. 3 shows a specific configuration of the checking server 1, which includes a holographic recording medium 20, an information processing device 30, and an optical system 40. As described above, the checking server 1 is provided with the image database 2, the retrieving light generating means 3, and the checking means 4, in which the holographic recording medium 20 constitutes a part of the image database 2, and the information processing device 30 and the optical system 40 constitute the retrieving light generating means 3 and the checking means 4.

In FIG. 3, the holographic recording medium 20 is a reflective recording medium with a thick hologram recording layer 21 composed of a photosensitive material, sandwiched between a surface protection layer 22 and a reflective layer 23. Image data is recorded on the hologram recording layer 21 of the holographic recording medium 20 by an interference fringe 24 resulting from information light generated on the basis of the registration image data and reference mark light generated on the basis of a reference mark. When a disk-shaped holographic recording medium is employed as the holographic recording medium 20, checking can be carried out while rotating the disk-shaped holographic recording medium, thereby allowing the checking speed to be increased. Furthermore, it is preferable that the holographic recording medium 20 include an address layer for specifying the location of the interference fringe 24. For example, pits may be formed as address information by a concavo-convex shape provided at the surface of the reflective layer 23 to use the reflective layer 23 as the address layer. The use of a glass substrate as the surface protection layer 22 of the holographic recording medium 20 can prevent contraction, etc. due to change in temperature, etc. As the reflective layer 23, a metal material such as aluminum can be used.

The information processing device 30 is connected to the network, and performs various types of information processing executed in the checking system. The types of information processing include, for example, reproduction of browsing image data and creation of images for retrieval, recording and reproduction of registration data, recording and reproduction of the correspondence relationship between the recording location of an interference fringe and registration image data, addition of identification data to browsing image data, determination of the order of checking on the basis of keyword data, transmission of information regarding image data, transmission of a warning message, etc.

The optical system 40 can record an interference fringe on the holographic recording medium 20, and check browsing image data against registration image data recorded on the holographic recording medium 20. The optical system 40 includes a laser 41 for hologram, a mirror 42, a spatial light modulator 43, a polarization beam splitter 44, a first relay lens 45, a mirror 46, a second relay lens 47, a beam splitter 48, a quarter wavelength plate 49, an object lens 50, an aperture 51, and a reference mark light detector 52, and further includes a laser 60 for addressing, a beam splitter 61, a mirror 62, and an address light detector 63.

The laser 41 for hologram serves as a light source for information light and reference mark light when an interference fringe is to be recorded, or serves as a light source for retrieving light when checking is to be carried out, for which, for example, short-wavelength high-power lasers such as blue lasers and green lasers are preferable. The spatial light modulator 43 has a plurality of pixels, and can spatially modulate light by changing the attribute of light for each pixel, for which, for example, a liquid crystal display device or a DMD (Digital Micromirror Device) can be used. In FIG. 3, a DMD is used as the spatial light modulator 32. The polarization beam splitter 44 transmits one of the linear polarized lights the directions of polarization of which is perpendicular to each other and reflects the other, transmits information light, reference mark light, and retrieving light directed to the recording medium 20, and reflects reference mark light reproduced by the recording medium toward the reference mark light detector 52. The first and second relay lenses 45, 47 form an image displayed on the spatial light modulator 43 onto the focal plane of the object lens. The beam splitter 48 is provided to direct light from the laser 60 for addressing toward the recording medium 20. The quarter wavelength plate 49 converts linearly polarized light into circularly polarized light, which can transmit linearly polarized light twice to rotate the linearly polarized light by 90 degrees. This quarter wavelength plate 49 causes reference mark light to transmit through the polarization beam splitter 44 for irradiation, or to be reflected by the polarization beam splitter 44 for reproduction. The object lens 50 applies Fourier transform to an image displayed on the spatial light modulator 43 to irradiate the hologram recording layer 21 of the recording medium 20. The aperture 51 has an opening which blocks retrieving light reflected by the recording medium 20 and transmits only reproduced reference mark light to the reference mark light detector 52. The reference mark light detector 52 detects a reproduced reference mark, and particularly preferably, detects the optical power of reference mark light, for which, for example, a pin photodiode, a CMOS sensor, and a CCD sensor can be used.

Light emitted from the laser 41 for hologram is reflected by the mirror 42, is spatially modulated by the spatial light modulator 43, transmits through the polarization beam splitter 44, is relayed by the first and second relay lenses 45, 47 between which the light is reflected by the mirror 46, transmits through beam splitter 48 and the quarter wavelength plate 49, and is subjected to Fourier transform by the object lens 50 to irradiate the hologram recording layer 21 of the recording medium 20. When reference mark light is reproduced in the hologram recording layer 21, the reference mark light reflected by the reflective layer 24 is emitted from the recording medium 20, transmits through the object lens 50, the quarter wavelength plate 49, the beam splitter 48, the first and second relay lenses 45, 47, and the mirror 46 in a direction opposite to the direction during the irradiation, is reflected by the polarization beam splitter 44, transmits through the aperture 51 and enters the reference mark light detector 52.

Furthermore, the laser 60 for addressing, the beam splitter 61, the mirror 62, and the address light detector 63 are provided to specify the irradiation position from an address layer when the recording medium 20 is provided with the address layer. Light emitted from the laser 60 for addressing transmits through the beam splitter 61, is reflected by the mirror 61 and further reflected by the beam splitter 48, and transmits through the quarter wavelength plate 49 to irradiate the address layer of the recording medium 20 by the object lens 50. Reflected light from the recording medium 20 transmits through the optical system in the reverse direction, is reflected by the beam splitter 61 and is detected by the address light detector 63. It is preferable to use, as the laser 60 for addressing, a relatively long-wavelength laser such as red light.

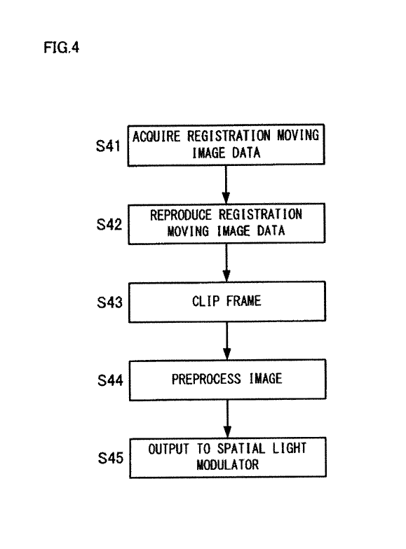

The operation of the checking server 1 will be described below. First, the operation will be described for recording, as the registration image data, moving image data (registration moving image data) on holographic recording medium 20 in order to create the image database 2. FIG. 4 is a flowchart of image processing in the information processing device 30.

The information processing device 30 reproduces registration moving image data provided by the registrant, and extracts a still image of frame of the moving image data to be recorded from the reproduced moving images (S41 to S43). Then, required preprocessing is applied to the extracted still image to generate an image for registration (S44), and the image for registration is output to the spatial light modulator 43 (S45). When the number of frames recorded is increased, the accuracy in checking can be increased. However, correspondingly, the number of interference fringes recorded is increased, thereby increasing the required storage capacity, and also making the time required for recording and checking longer. Therefore, in the case of extracting a frame to be recorded from the moving image data, it is preferable that the number of recorded frames per unit time (fps: frames per second) be made variable in such a way that the number of recorded frames is increased in situations with dramatic changes, whereas the number of recorded frames is decreased in situations with slight changes. For example, general digitized moving image data is compressed with the use of VBR (Variable Bit Rate), which is higher in situations with dramatic changes and lower in situations with slight changes. Therefore, the fps may be changed on the basis of the bit rate.

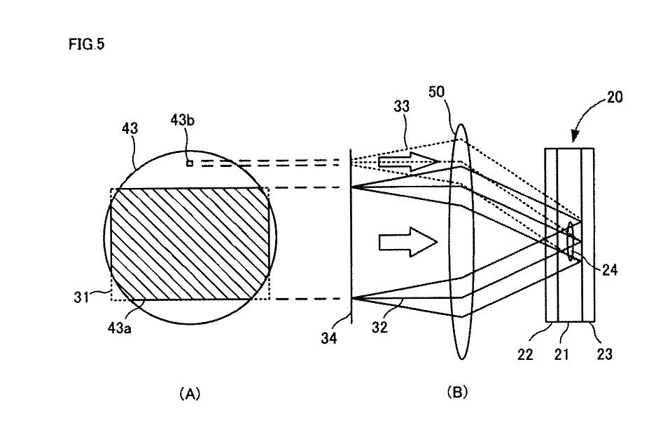

FIG. 5(A) is a schematic diagram illustrating a display surface in the spatial light modulator 43, and FIG. 5(B) is a schematic diagram illustrating the operation of recording an interference fringe resulting from information light 32 and reference mark light 33. It is to be noted that a surface 34 on which an image is displayed in FIG. 5(B) (a surface on which an image is formed by the relay lenses 45, 47 in FIG. 3) is located spaced apart from the object lens 50 by the focal length f of the object lens 50. In FIG. 5(A), an image 31 for registration input from the information processing device 30 is displayed on a partial region 43a (a diagonally shaded portion in FIG. 6(A)) of the spatial light modulator 43 which is circular, to spatially modulate light from a light source 41, thereby generating the information light 32. The spatial light modulator 43 displays a reference mark on another partial region 43b to modulate light from the light source 41, thereby generating the reference mark light 33. Then, the information light 32 and the reference mark light 33 are subjected to Fourier transform by the object lens 50, and interfere with each other in the thick hologram recording layer 21 of the recording medium 20, and the interference fringe 24 is sterically recorded on the thick hologram recording layer 21 (more specifically, a volume hologram is formed). Subsequently, each image 31 for registration from the image data is sequentially recorded in different positions of the hologram recording layer 21, thereby registering the moving image data in the image database. The generation of the information light and the reference mark light by the same spatial light modulator 43, as described above, can bring the information light and the reference mark light in phase, and can form a strong interference fringe.

At least a portion of the image 31 for registration is displayed on the region 43a of the spatial light modulator 43. Of course, the region 43a may be a region large enough to display the entire image 31 for registration. Furthermore, the region 43a does not necessarily have the same shape as that of the image 31 for registration, as long as an image can be displayed which is enough for computing optical correlation with an image for retrieval. In FIG. 5(A), the region 43a is slightly smaller than the image size of the image 31 for registration, and the spatial light modulator 32 is circular. Therefore, the four corners of the image 31 for registration fail to be displayed. However, since most of the image is displayed, it is possible to compute optical correlation between the interference fringe and retrieving light generated from the image for retrieval.

As for the region 43b of the spatial light modulator 43, at least one is located around the region 43a, on which a reference mark is displayed. The information light 32 and the reference mark light 33 are diffracted by the spatial light modulator, thereby resulting in collection of divergent rays from each pixel, and the divergent rays from each pixel in terms of the information light and the reference mark light are brought into parallel rays by the object lens 50 to irradiate the recording medium 20, thereby as a whole allowing the converging information light and reference mark light to be crossed, and allowing an interference fringe to be formed (see FIG. 5(B)). Furthermore, the reference mark light is used to determine the result of computing optical correlation between an image for retrieval and an image for registration when checking is to be carried out, and the easiness of the detection affects the speed of the retrieval. It is preferable as the result of computing the optical correlation to employ a system for detecting the optical power of the reference mark light. It is to be noted that the region 43b on which a reference mark is displayed is not limited to having a quadrangular shape, and may have various shapes, and the reference mark itself may be a spatially modulated pattern, for example, a random pattern.

In FIG. 5(A), the region 43b is located above the region 43a on which the image 31 for registration is displayed, which is a much smaller region of 4 pixels (2×2 pixels) as compared with the region 43a. Therefore, the reference mark light 33 diverges like a point source of light, and interfere with the information light 32 to form an interference fringe. It is to be noted that the region 43a has a size of seventy thousand or more pixels, which is enough to display most of the image 31 for registration of 320×240 pixels.

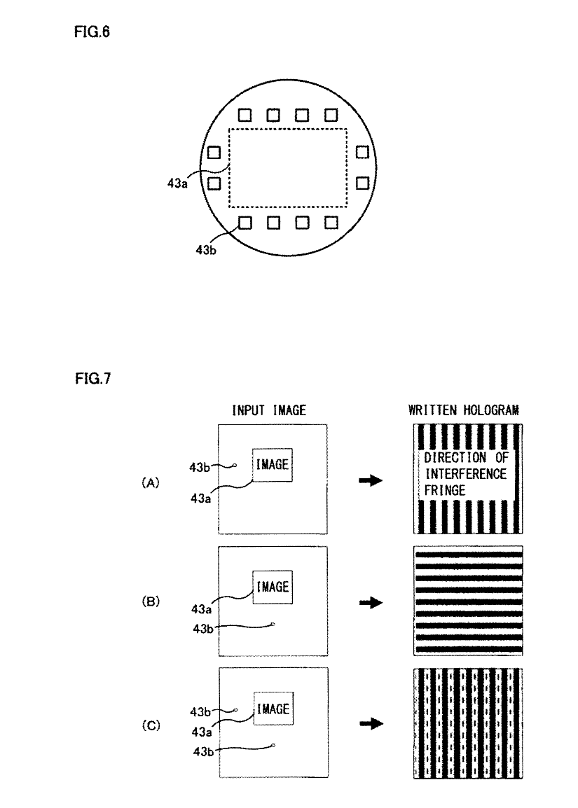

As shown in FIG. 6, reference marks may be displayed on multiple points to form an interference fringe with the use of multiple rays of reference mark light. FIG. 6 is a schematic diagram illustrating a display surface in a spatial light modulator 43, in which twelve regions 43b on which a reference mark of 400 pixels (20×20 pixels) is displayed are arranged around a region 43a (indicated by a dotted line) on which an image 31 for registration is displayed. FIG. 7 is a diagram expressing the relationship between the location of the reference mark 43b and an interference fringe written in the hologram, where FIG. 7(A) shows an interference fringe obtained when recording is carried out with the reference mark 43b located on the left side of the image 43a, FIG. 7(B) shows an interference fringe obtained when recording is carried out with the reference mark 43b located below the image 43a, and FIG. 7(C) shows an interference fringe obtained when recording is carried out with the reference marks 43b located on the left side of and below the image 43a. The interference fringe indicates an interference of a point source of light through the reference mark 43b with the image 43a. Thus, the fringe appears in a direction in which the optical path difference between the point source of light and the image is the integral multiple of a wavelength λ. Therefore, the direction of the interference fringe varies depending on where the point source of light is located with respect to the image. In addition, as in FIG. 7(C), when the point sources of light are arranged so that interference fringes appear in different directions, a two-dimensional interference fringe is formed. Such a two-dimensional interference fringe can increase the shift allowance for the image for retrieval when checking is to be carried out. More specifically, even if the position of the image for retrieval is shifted from side to side or up and down with respect to the image for registration, the range in which the reference mark can be reproduced is expanded. It is to be noted that while the region 43b has the size of 400 pixels with the number of regions 43b being 12 in FIG. 6, the size of the region 43b and the number thereof can be appropriately changed.

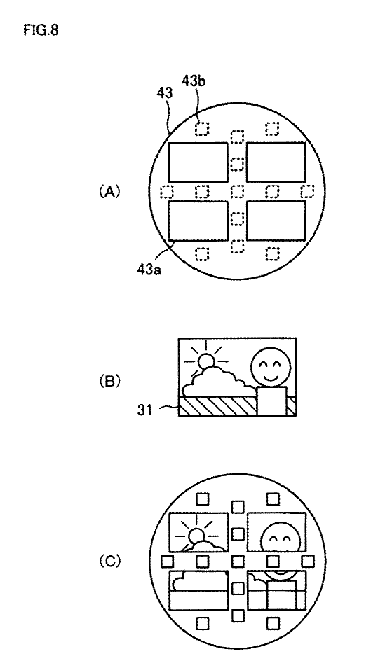

More preferably, as shown in FIGS. 8(A) to 8(C), a partial region 43a of the spatial light modulator, on which the image for registration is displayed, is divided into multiple spaced-apart regions, the image 31 for registration is divided and displayed on the multiple spaced-apart regions, and at least some of regions 43b on which a reference mark is displayed are located between the multiple spaced-apart regions. FIG. 8(A) is a schematic diagram illustrating a display surface in the spatial light modulator 43, FIG. 8(B) shows an example of the image 31 for registration, and FIG. 8(C) is a diagram illustrating the state of a divided image for registration displayed on the region 43a of the spatial light modulator 43. In FIG. 8(A), the region 43a (indicated by a solid line) on which the image for registration is displayed is divided into four parts, and the image 31 for registration is divided into four parts and displayed. Thirteen regions 43b (indicated by dotted lines) on which a reference mark of 400 pixels (20×20 pixels) is displayed are arranged in a cross portion between the regions 43a and above and below the regions 43a. It is to be noted that while multiple quadrangular regions are arranged in FIG. 8 for the regions 43b on which a reference mark is displayed, the region in the shape of “ [symbol] ”, composed of the cross portion between the regions 43a and the periphery thereof, may be used as the region 43b, the entire region in the shape of “ [symbol] ” may be used for a reference mark, or the pixels in the region 43b may be turned on in a random manner.

The effect on the checking result due to the difference in the display mode for the region 43a on which the image for registration is displayed and the region 43b on which a reference mark is displayed in these spatial light modulators 43 will be described with reference to FIGS. 9 to 11. FIGS. 9 to 11 are diagrams each showing error rates in databases recorded in accordance with each display mode, when the vertical axis indicates an error rate whereas the horizontal axis indicates a threshold value for a normalized correlation signal (optical power of reference mark light). The error rate is composed of two error curves, when one of the error curves indicates a registered image rejection rate (FRR: False Rejection Rate) in the case of false recognition of a registered image as an unregistered image, whereas the other indicates an other image acceptance rate (FAR: False Acceptance Rate) in the case of false recognition of a different image as a recorded image. The registered image rejection rate FRR and the other image acceptance rate FAR are each obtained from the true/false rate of the checking result in the case of varying the threshold value. FIGS. 9 to 11 show the registered image rejection rate FRR and the other image acceptance rate FAR obtained when an image database in which 9000 images for registration are registered is created by preparing 30 pieces of moving image data for 10 seconds and recording each piece at 30 fps (frame/second), one frame is extracted from each of the 30 pieces of registered moving image data to check each of the 30 images for retrieval against the 9000 images for registration, and the acquired correlation signal is compared with the threshold value to determine cases of the correlation signal being greater as images for registration.

The value at which the registered image rejection rate FRR and the other image acceptance rate FAR intersect with each other refers to a threshold value at which both of the registered image rejection rate FRR and the other image acceptance rate FAR are minimized, where the error rate at the value is referred to an EER (Equal Error Rate), and when the EER has a certain range, the range is referred to as a threshold value region. In FIGS. 9 to 11, the range of the threshold value region is denoted by alternate long and short dashed lines. The EER is preferably as small as possible, and if the EER is 0%, the registered image rejection rate FRR and the other image acceptance rate FAR are both 0%, and no error occurs in theory. In addition, the extent of the threshold value region indicates the degree of reliability of checking, and the larger extent means the higher degree of reliability of checking. It is to be noted that in order to also allow similar images to be checked, the threshold value may be deliberately made smaller than the threshold value region to increase the other image acceptance rate FAR.

FIGS. 9(A) to 9(C) show cases in which the region 43b on which one reference mark is displayed is located above the region 43a on which an image for registration is displayed, as shown in FIG. 5, to carry out recording, when FIG. 9(A) shows the result of locating a reference mark of 2×2=4 pixels, FIG. 9(B) shows the result of locating a reference mark of 10×10=100 pixels, and FIG. 9(C) shows the result of locating a reference mark of 20×20=400 pixels. The EER and threshold value region for FIGS. 9(A) to 9(C) are shown in the second to fourth lines (the three lines in which the reference mark location is “above”) of Table 1. From FIGS. 9(A) to 9(C), it can be seen that when the reference mark is located on one point, the EER can be reduced while the threshold value region can also be extended in the case of the reference mark of four pixels (FIG. 9(A)) more than in the case of the reference mark of 100 pixels or 400 pixels (FIG. 9(B) or 9(C)). It is estimated that this is because the smaller reference mark increases divergence in the spatial light modulator, allowing interference with the information light in a broader range. As compared with the 100 pixels or 400 pixels, the EER and the threshold value region are more favorable in the case of 10 pixels or less.

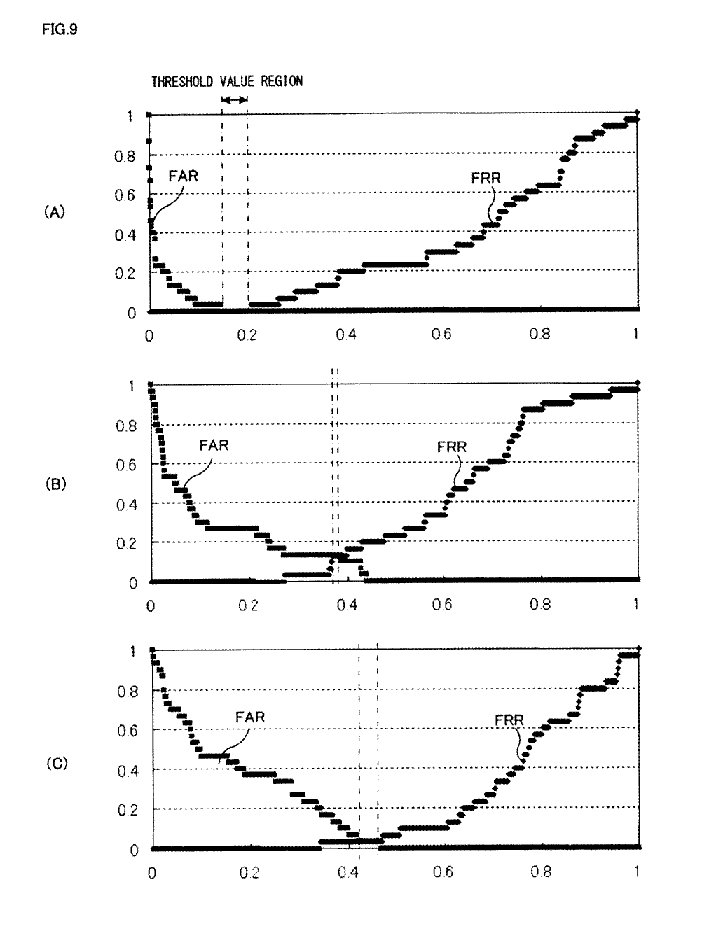

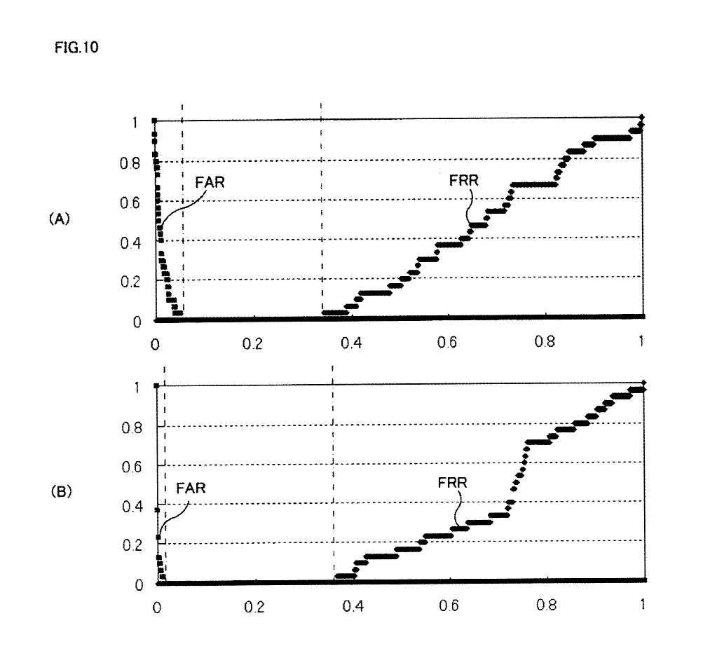

FIGS. 10(A) and 10(B) show cases in which the region 43b on which multiple reference marks are displayed is located around the region 43a on which an image for registration is displayed as shown in FIG. 6 to carry out recording, when FIG. 10(A) shows the result of locating twelve reference marks of 20×20=400 pixels, and FIG. 10(B) shows the result of locating forty reference marks of 10×10=100 pixels. The EER and threshold value region for FIGS. 10(A) and 10(B) are shown in the fifth to sixth lines (the two lines in which the reference mark location is “around”) of Table 1. When FIGS. 10(A) and 10(B) are compared with FIGS. 9(A) to 9(C), it can be seen that the EER can be more reduced while the threshold value region can also be more extended in the case of the multiple reference marks located around.

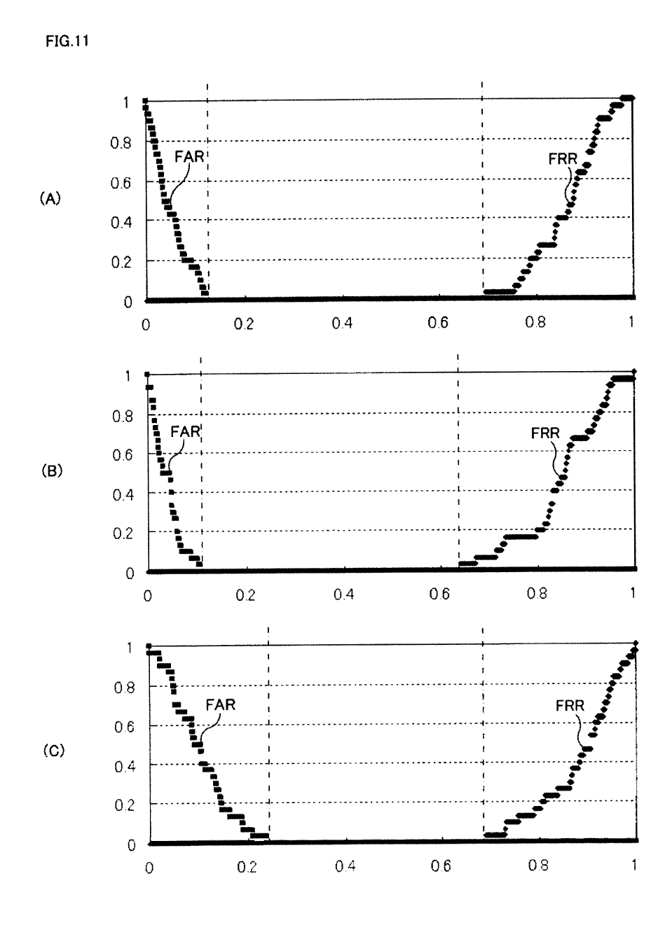

FIGS. 11(A) to 11(C) show cases in which the region 43a on which an image for registration is displayed is divided into parts whereas the region 43b on which multiple reference marks are displayed is located between the parts and around the parts, as shown in FIG. 8, to carry out recording, where FIG. 11(A) shows the result of dividing the region 43a into four parts and locating twelve reference marks of 20×20=400 pixels, FIG. 11(B) shows the result of dividing the region 43a into four parts and locating forty reference marks of 10×10=100 pixels, and FIG. 11(C) shows the result of dividing the region 43a into nine parts and locating forty reference marks of 10×10=100 pixels. The EER and threshold value region for FIGS. 11(A) to 11(C) are shown in the seventh to ninth lines (the three lines in which the reference mark location is “between . . . parts”) of Table 1. When FIG. 11 is compared with FIG. 10, it can be seen that the threshold value region can be most extended in the system in which the region 43a on which an image for registration is displayed is divided into parts to display multiple reference marks between the parts and around the parts.

TABLE 1

| | | The Number | | Threshold | |
|---|---|---|---|---|---|
| Reference Mark | | of Reference | EER | Value | |
| Location | Size | Marks | (%) | Region | Figure |
| above | 4 (2²) | 1 | 0.0 | 0.05 | 9(A) |
| above | 100 (10²) | 1 | 13.3 | 0.02 | 9(B) |
| above | 400 (20²) | 1 | 3.3 | 0.05 | 9(C) |
| around | 400 (20²) | 12 | 0.0 | 0.35 | 10(A) |
| around | 100 (10²) | 40 | 0.0 | 0.35 | 10(B) |
| between 4 parts | 400 (20²) | 13 | 0.0 | 0.58 | 11(A) |
| between 4 parts | 100 (10²) | 40 | 0.0 | 0.53 | 11(B) |
| between 9 parts | 100 (10²) | 40 | 0.0 | 0.45 | 11(C) |

Furthermore, it is preferable to specify the recording location of the interference fringe 24 from the address layer with the use of the laser 60 for addressing and the address light detector 63, and to record on a recording means or the like of the information processing device, the correspondence relationship between the recording location of the interference fringe 24 and the recorded image 31 for registration or the registration moving image data, when the interference fringe 24 is to be recorded. If this correspondence relationship is recorded, the location of the interference fringe obtained by reproducing the reference mark light is specified from the address layer, thereby allowing the image 31 for registration or registration moving image data with its interference fringe 24 recorded to be specified, when checking is to be carried out. In addition, when the registrant sets registration data as the registration image data, the correspondence relationship between the registration data and the recording location of the registration image data or its interference fringe 24 is recorded on a recording means or the like of the information processing device.

Next, operation for checking will be described. FIG. 12 is a flowchart of processing for checking in the checking server 1. The information processing device 30 acquires browsing image data to generate an image for retrieval, and outputs the image for retrieval to the spatial light modulator 43 (S81 to S83). Then, in the optical system 40, retrieving light is generated to irradiate the interference fringe 24 on the recording medium 20 with the retrieving light (S84, S85). Then, it is determined whether or not reference mark light is reproduced, and if no reference mark light is reproduced (S86→S87), the next interference fringe is irradiated with the retrieving light (S87→S85). If there is not the next interference fringe (S87→S88), retrieval is carried out for the next image for retrieval (S88→S83). However, if there is not the next image for retrieval (S88→S89), it is determined that no browsing image data is registered in the image database 2, and the results of checking is added as identification data. If reference mark light is generated (S86→S90), the optical power of the generated reference mark light is compared with the threshold value. Then, if the optical power is less than the threshold value (S90→S87), the next interference fringe is irradiated with the retrieving light (S87→S85). If the optical power is the threshold value or more (S90→S91), the recording location of the interference fringe is specified, and registration data on registration image data in the recording location is retrieved to add those results of checking as identification data (S91, S92, S89). It is to be noted that in the case of the threshold value or more, checking may also remain continued to carry out checking against all data of the image database.

In processing for creating the image for retrieval (S82), the same processing as the image processing in FIG. 4 may be carried out for the browsing image data. It is to be noted, when the browsing image data is moving image data, that while the image for retrieval is created on the basis of at least one frame image extracted from images obtained by reproducing the browsing moving image data, the accuracy in checking can be improved if multiple frame images in different scenes are used as images for retrieval. Furthermore, it is preferable to apply, to the image for retrieval, the same preprocessing as that for the image 31 for registration, and to display the image for retrieval on the spatial light modulator in the same display mode as that for the image for registration.

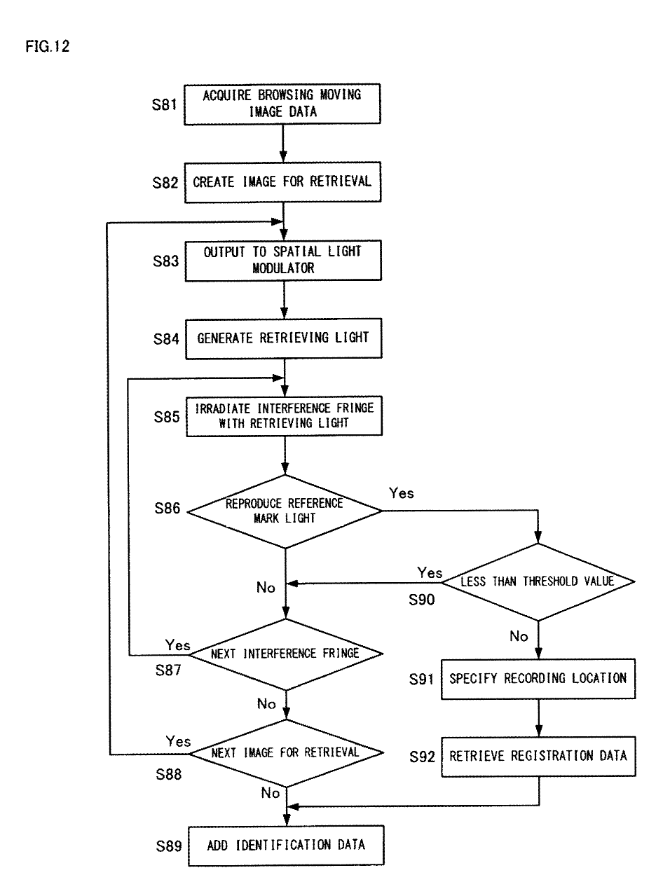

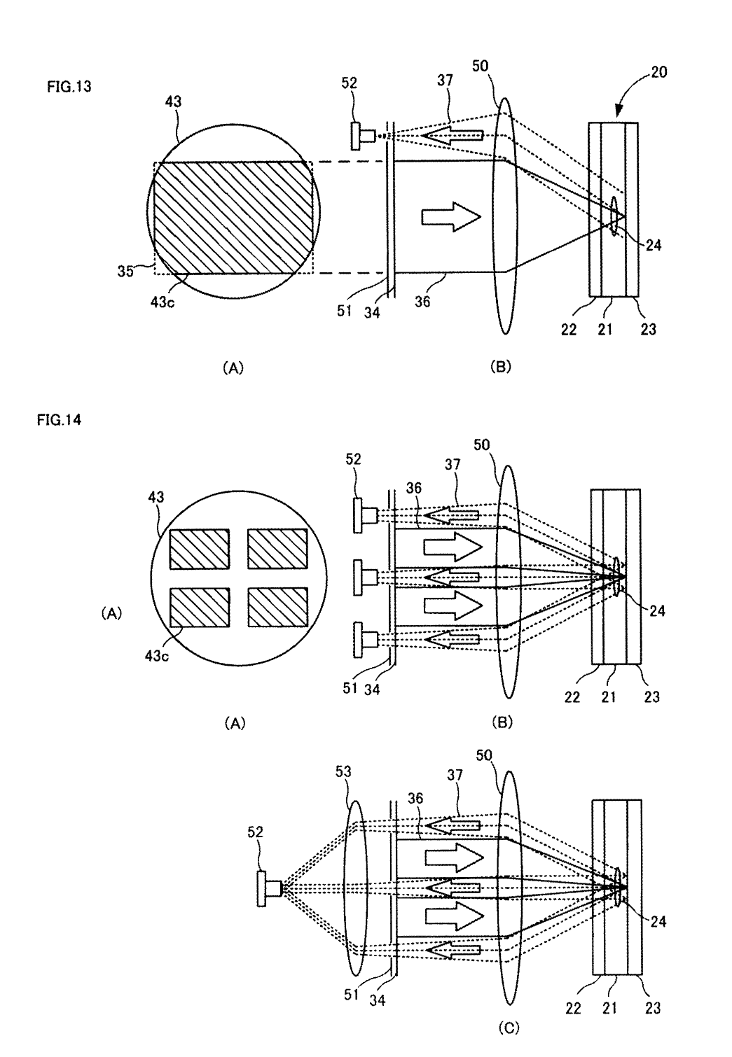

FIG. 13(A) is a schematic diagram illustrating a display surface in the spatial light modulator 43, and FIG. 13(B) is a schematic diagram illustrating the operation of checking with retrieving light 36. It is to be noted that FIG. 13 shows a case of checking for the image database recorded in the display mode in FIG. 5, and a surface 34 on which an image is displayed in FIG. 13(B) is located spaced apart from the object lens 50 by the focal length f of the object lens 50. In FIG. 13(A), an image 35 for retrieval input from the information processing device 30 is displayed on a partial region 43c (a diagonally shaded portion in FIG. 13(A)) of the spatial light modulator 43 which is circular, to spatially modulate light from a light source 41, thereby generating the retrieving light 36. Then, the retrieving light 36 is subjected to Fourier transform by the object lens 50, with which the interference fringe 24 recorded on the thick hologram recording layer 21 of the recording medium 20 is irradiated. The higher the degree of similarity between the image for retrieval and the image for registration is, the stronger the interference of the retrieving light 36 with the interference fringe 24 is, and reference mark light 37 (correlation signal) is strongly reproduced as a result of computing optical correlation. The reproduced reference mark light 37 is made by the object lens 50 to form a reference mark on the display surface 34, passes through an opening of an aperture 51 located near the display surface 34, and then is detected by the reference mark light detector 52.

It is preferable that the region 43c on which the image 35 for retrieval is displayed have the same extent as the region 43a on which the image 31 for registration is displayed. Also in FIG. 13(A), the region 43c is slightly smaller than the image size of the image 35 for retrieval, and has the same extent as the region 43a in FIG. 5(A) which is not able to display the four corners of the image 35 for retrieval.

The reference mark light detector 52 detects at least the optical power of the reference mark light, the detected optical power of the reference mark light is compared with a predetermined threshold value in the information processing device, and if the optical power is less than the threshold value, with the result as mismatching, another interference fringe or another image for retrieval is used to continue the processing for checking. If the optical power is the threshold value or more, the laser 60 for addressing and the address light detector 63 are used to specify the recording location of the interference fringe 24 from the address layer. Furthermore, from the correspondence relationship between the recording location of the interference fringe 24 recorded on a recording means or the like of the information processing device and the image for registration or the registration moving image data, the image for registration or the registration moving image data is specified for the interference fringe 24, and registration data on the registration moving image data recorded on a recording means or the like of the information processing device is also read out to retrieve information which is to be added as identification data to the browsing moving image data. It is to be noted that these types of processing are not necessary when a portion of the registration data is not to be contained as identification data.

FIG. 14(A) is a schematic diagram illustrating a display surface in the spatial light modulator 43 for the case of checking an image database recorded in the display mode in FIG. 8, FIG. 14(B) is a schematic diagram illustrating the operation of checking with retrieving light 36, and FIG. 14(C) shows a modification example of FIG. 14(B). It is to be noted that a surface 34 on which an image is displayed in FIGS. 14(B) and 14(C) is located spaced apart from the object lens 50 by the focal length f of the object lens 50. In FIG. 14(A), a region 43c (a diagonally shaded portion in FIG. 14(A)) on which an image for retrieval is displayed is divided in the same way as the region on which an image for registration is displayed in recording. A divided image for retrieval is displayed on the region 43c to spatially modulate light from the light source 41, thereby generating the retrieving light 36. Then, the retrieving light 36 is subjected to Fourier transform by the object lens 50, with which the interference fringe 24 recorded on the thick hologram recording layer 21 of the recording medium 20 is irradiated. Reference mark light 37 (correlation signals) reproduced by the retrieving light 36 is generated as multiple rays in the same way as in the arrangement in recording, and made by the object lens 50 to form multiple reference marks on the display surface 34. Furthermore, the reference mark light 37 and the retrieving light 36 are separated from each other by an aperture 51 with openings in the positions of the reference marks to detect the reference mark light 37 by multiple reference mark light detectors 52 (FIG. 14(B)). In this case, as shown in FIG. 14(C), when a lens 53 is provided which collects multiple rays of the reference mark light 37 almost onto one point, the correlation signals can be detected by one reference mark light detector 52. Such collection and detection of light reproduced from holography has not been conceived in any way from conventional holographic record reproduction for reproducing two-dimensional images.

In the description above, since a collinear type apparatus is employed in which information light is allowed to coaxially interfere with reference light, it is possible to carry out checking at high speed. It is to be noted that while the reflective holographic recording medium has been described in the description above, it is also possible to achieve the present invention with a transmission holographic recording medium which transmits and then displays reference mark light reproduced by computing optical correlation. In addition, it is also possible to achieve the present invention with a two-beam interference type apparatus in which the optical path of information light and the optical path of the reference mark light are separated from each other and crossed at a given degree in a recording medium, rather than the collinear type apparatus. For example, the configuration may be employed in which light from the light source 41 is divided into two light rays by a beam splitter, one of the light rays is modulated by the spatial light modulator to generate information light whereas the other light ray is shaped to generate reference mark light, and the two types of light are used for irradiation so as to be crossed on the recording medium.

In FIG. 12, in the case of the threshold value or more, it is determined that the browsing moving image data is matched with the registration image data. However, since there is a possibility that several tens of thousands of pieces of registration image data include similar images, it is preferable to carry out the processing for checking with the use of frame images in different scenes of the browsing moving image data as images for retrieval, rather than making a determination with the use of only retrieving light from one image for retrieval. This processing for checking can be carried out for a short period of time since the location of the interference fringe of possibly related registration image data has been already specified to some extent.

Furthermore, when at least one piece of keyword data is added to the browsing image data, the order of the interference fringe, recording medium, or image database to be subjected to checking is determined on the basis of the keyword data, thereby allowing processing for checking to be carried out efficiently. In the case of employing keyword data, it is first necessary to set a keyword for the registration image data by registration data or other recognition means. The keyword may be recorded to correspond to each interference fringe, each piece of registration image data, each recording medium, or each image database. For example, a keyword is recorded in addition to the correspondence relationship between the recording location of each interference fringe and the registration image data, a keyword is set for each recording medium, followed by recording registration image data with the keyword, or an image database is provided for each keyword, followed by recording registration image data with the keyword. Then, in checking, a holographic recording medium on which registration image data is recorded with a set keyword acquired from keyword data added to the browsing image data is irradiated first with retrieving light, thereby increasing the rate of being able to carry out early checking. Therefore, checking can be carried out efficiently.

The keyword can be set, for example, from rough classifications such as films, TV programs, original videos, and music, to further fine classifications such as Japanese films, foreign films, dramas, variety shows, news programs, animated cartoons, and CM.

As described above, the output signal from the reference mark light detector 52 is monitored while irradiating each interference fringe on the recording medium with retrieving light, thereby allowing an interference fringe on which an image for registration highly correlated with an image for retrieval is recorded to be retrieved so that the browsing image data can be checked against the registration image data. It is to be noted that it is also possible in checking to employ a configuration in which a checking result eventually considered appropriate is determined after acquiring correlation signals for all of interference fringes.

Meanwhile, in conventional holographic record reproduction, reference light is allowed to interfere with information light to form an interference fringe in recording, while irradiation with the reference light is carried out to reproduce the information light in reproduction. Such holographic record reproduction is significantly characterized in that information light with a staggering amount of information, such as two-dimensional images, can be recorded and reproduced, but it is necessary in reproduction to detect the staggering amount of information of the information light, such as two-dimensional images. Therefore, a high-performance detection means in which light receiving elements are two-dimensionally arranged is used to reproduce two-dimensional images, etc. However, in order to detect the two-dimensional distribution of the optical power, irradiation with reference light needs to be carried out to some extent to increase the quantity of the reproduced information light, and the reproduction speed and the transfer rate are limited since the throughput of the detection means is also limited. In contrast, the checking means 4 described above only detects the power of the reference mark light, and need not reproduce an image for registration from an interference fringe on the holographic recording medium, thereby allowing processing to be carried out at an extremely high speed. In particular, the configuration in which reproduced light is collected and detected on one point, as typified by the lens 53 in FIG. 14(C), is not able to be employed in the conventional holographic record reproduction for detecting the two-dimensional distribution of the optical power.

Furthermore, in the conventional holographic record reproduction, which is recognized as an alternative to general-purpose recording media, the recording rate is also an important factor, and as a result, it is necessary to use a spatial light modulator that can be switched at high speed. However, it is enough for the holographic recording medium 2 according to the present invention to only achieve speeding up in checking, and the recording rate in recording or the transfer rate is not particularly important. Therefore, ferroelectric liquid crystal display devices, etc. which are slow in switching of the display can also be used as the spatial light modulator. It is to be noted that in checking the switching rate is loosely limited since the same image for retrieval is displayed on the spatial light modulator for a certain period of time.

[Example] 10 fps (frames/second) of images for registration, that is, 10 frame images for a moving image for one second were extracted to record moving image data. When interference fringes about 200 μm in diameter are recorded on a holographic recording medium in the shape of a 12 cm disc to be spaced 20 μm apart in the track direction and spaced 20 μm apart in the radial direction, about 170 pieces (=15,300 minutes=9,180,000 images for registration) of moving image data for 90 minutes can be recorded on one holographic recording medium. 50 pieces (=4,500 minutes=2,700,000 images for registration) of moving image data for 90 minutes were recorded on this holographic recording medium at 10 fps to create a database. Then, when irradiation with retrieving light generated on the basis of an image for checking was carried out to carry out processing for checking, while rotating the holographic recording medium at the number of revolutions of 2400 rpm, 753,600 images could be subjected to checking for one second, and all of the images in the database could be subjected to checking for 3.6 seconds. The transfer rate in this case was about 250 Gbps. Further, when the number of revolutions of the holographic recording medium is set at 5000 rpm, retrieval can be completed for 1.7 seconds. If the utmost of the storage capacity of the holographic recording medium is used to record 170 pieces of moving image data of 90 minutes, checking can be completed for 12.2 seconds. Furthermore, the use of multiple holographic recording mediums eliminates the limitation to the storage capacity of the image database, and the checking time can also be kept if the processing for checking is carried out in parallel by multiple devices. Therefore, a checking system can be provided which can always handle a huge number of posted images.

[Comparative Example] In conventional hard disks, while it was also possible to create a database of 1 TB (=1000 GB), the transfer rate was generally from 300 Mbps to at most 3 Gbps or less. Even if currently available high-performance computers, for example, a computer including a CPU with a frequency of 3.00 GHz and a RAM of 1.99 GB is used to optimize the calculation, checking for one second was limited to 100 to 1000 images (a moving image for 10 to 100 seconds) of a database recorded on a hard disk In a system using such a hard disk, for example, a time period of at least 45 minutes was required to check one image, with respect to a database created in the hard disk, in which 50 pieces (=4,500 minutes=2,700,000 images for registration) of moving image data for 90 minutes have been recorded at 10 fps. In other words, checking is completed for 3.6 seconds in the checking system in Example, while it takes 750 times as long time as in the case of using the hard disk From another point of view, in the case of using the hard disk, 750 computers are operated in parallel to manage to achieve the checking speed comparable to that in Example. Accordingly, Example not only allows the speed of processing to be increased, but also leads to reduction in power consumption and capital investment cost.

1. A checking system for checking browsing image data that can be in a browsing state on a site on a network, characterized in that it comprises:
an image database in which multiple pieces of registration image data are registered; a retrieving light generating means for generating retrieving light on the basis of the browsing image data; and a checking means for checking the browsing image data against the registration image data registered in the image database,
the image database includes a holographic recording medium comprising a hologram recording layer on which image data is recorded by an interference fringe resulting from information light generated on the basis of registration image data and reference mark light generated on the basis of a reference mark, and
the checking means irradiates the hologram recording layer of the holographic recording medium with retrieving light generated by the retrieving light generating means, and detect reproduced reference mark light to check the browsing image data against the registration image data.

2. The checking system according to claim 1, characterized in that identification data is added to the browsing image data when the browsing image data is registered in the image database.

3. The checking system according to claim 2, characterized in that a condition for browsing the browsing image data is changed on the basis of the identification data.

4. The checking system according to claim 1, characterized in that the holographic recording medium is provided with an address layer for specifying a location, and when reference mark light is reproduced by the retrieving light, the location of a reference fringe reproducing the reference mark light is specified by using the address layer, and the browsing image date is specified from the location of the interference fringe.

5. The checking system according to claim 1, characterized in that when the browsing image data is registered in the image database, information regarding the image data is provided to a registrant who registers the image data in the image database.

6. The checking system according to any claim 1, characterized in that irradiation with the retrieving light is carried out while rotating the holographic recording medium which has the shape of a disc.

7. The checking system according to claim 1, characterized in that the information light is spatially modulated by an image for registration generated from an reproduced image of the registration image data displayed on a partial region of a spatial light modulator, and the reference mark light is modulated by the reference mark displayed on another partial region of the spatial light modulator.

8. The checking system according to claim 7, characterized in that a partial region of the spatial light modulator on which the image for registration is displayed is divided into a plurality of spaced-apart regions, the image for registration is divided and displayed on the plurality of spaced-apart regions, and at least a portion of a region on which the reference mark is placed between the plurality of spaced-apart regions.

9. The checking system according to claim 7, characterized in that the retrieving light is spatially modulated by an image for retrieval generated from a reproduced image of the browsing image data, and the image for retrieval is displayed on a partial region of the spatial light modulator on which the image for registration is displayed.

10. The checking system according to claim 1, characterized in that the registration image data is provided with at least one keyword,
at least one keyword is added to the browsing image data, and
the checking means first irradiate, with retrieving light, the holographic recording medium on which the registration image data provided with the keyword acquired from the keyword data is recorded, when the checking means checks the browsing image data.

11. The checking system according to claim 1, characterized in that at least moving image data is contained in the registration image data,
the information light is generated on the basis of a still image of frame extracted from reproduced moving images obtained by reproducing the moving image data, and
the number of frames per unit time extracted from the reproduced moving images is variable.
